(19) United States
(12) Patent Application Publication
(10) Pub. No.: US 2008/0297049 A1
(43) Pub. Date: Dec. 4, 2008

(54) PLASMA DISPLAY PANEL AND METHOD FOR FABRICATING THE SAME

(75) Inventors: Jae Yong HAN, Seoul (KR); Sung Tae Kim, Seoul (KR); Nam Seok Kang, Seongnam-si (KR)

Correspondence Address: KED & ASSOCIATES, LLP, P.O. Box 221200, Chantilly, VA, 20153-1200, US

(73) Assignee: LG Electronics Inc.

(21) Appl. No.: 12/128,280

(22) Filed: May 28, 2008

(30) Foreign Application Priority Data
Jun. 1, 2007 (KR) 10-2007-0053817

(51) Int. Cl. H01J 17/49; H01J 9/24

(52) U.S. Cl. 313/582; 445/24

(57) ABSTRACT

A plasma display panel and method are provided to reduce noise. The plasma display panel may include a first substrate including a first electrode, a second substrate facing the first substrate, the second substrate including a second electrode, and barrier ribs arranged between the first substrate and the second substrate to partition discharge cells. The plasma display panel may also include a first adhesion layer arranged between the first substrate and each of the barrier ribs, and a second adhesion layer arranged between the first substrate and the second substrate.

This application claims the benefit of Korean Patent Application No. 10-2007-0053817, filed Jun. 1, 2007, the subject matter of which is incorporated herein by reference.

### BACKGROUND

1. Field

Embodiments of the present invention may relate to a plasma display panel and a method for fabricating a plasma display panel. More particularly, embodiments of the present invention may relate to a method for fabricating a plasma display panel, capable of reducing noise and a plasma display panel fabricated by the method.

2. Background

With the advent of a multimedia age, there has been a demand for displays that can exhibit a higher definition, have a larger screen and render colors more approximate to natural colors.

Since cathode ray tubes (CRTs) have a limitation in realizing a large (i.e., 40 inch or more) screen, displays such as liquid crystal displays (LCDs), plasma display panels (PDPs) and projection televisions (TVs) are being rapidly developed so that their applications can extend to the high-quality image field.

The plasma display panel is an electronic device that uses a plasma discharge to display images. When a predetermined voltage is applied to electrodes arranged in a discharging space of the PDP, plasma discharge occurs between the electrodes. Vacuum ultra violet (VUV) generated during this plasma discharge excites phosphor layers formed in a predetermined pattern to thereby form an image.

PDPs include an upper substrate having sustain electrode pairs, an upper dielectric and a passivation film arranged in this order, and a lower substrate having an address electrode, a lower dielectric and barrier ribs arranged in this order.

The barrier ribs may partition discharge cells and a phosphor layer may be arranged in each of the discharge cells.

The upper substrate and the lower substrate may be joined together using an adhesive, and a discharge gas may then be injected into the discharge cells to complete fabrication of a plasma display panel.

In the progress of fabricating plasma display panels, the joining of the upper substrate and the lower substrate may be carried out by applying an adhesive to a space between the edges of the substrates and pressing the substrates into each other.

In such a joining method, fine gaps between the upper substrate and barrier ribs are formed due to substrate bending and non-uniform internal surfaces of the substrates.

Inevitably, the gaps may involve occurrence of noise due to resonance of shock waves generated during panel discharge.

Furthermore, the fine gaps formed between the upper substrate and the barrier ribs may cause deterioration of discharge efficiency and occurrence of panel warping, thus disadvantageously degrading reliability of PDPs.

### BRIEF DESCRIPTION OF THE DRAWINGS

Embodiments and arrangements may be described in detail with reference to the following drawings in which like reference numerals refer to like elements and wherein:

FIGS. 1A to 1C are views illustrating a plasma display panel according to embodiments of the present invention;

FIGS. 2A and 2B are views illustrating a shape of an adhesion layer according to embodiments of the present invention;

FIG. 3 is a view illustrating a driver and a connection part of the plasma display panel according to an embodiment of the present invention;

FIG. 4 is a view illustrating a structure of a wiring substrate of a tape carrier package (TCP);

FIG. 5 is a schematic view illustrating an embodiment of the TCP shown in FIG. 4; and

FIGS. 6A to 6P are views illustrating a method for fabricating a plasma display panel according to embodiments of the present invention.

### DETAILED DESCRIPTION

Structure and operation of a plasma display panel (PDP) according to embodiments of the present invention will now be described.

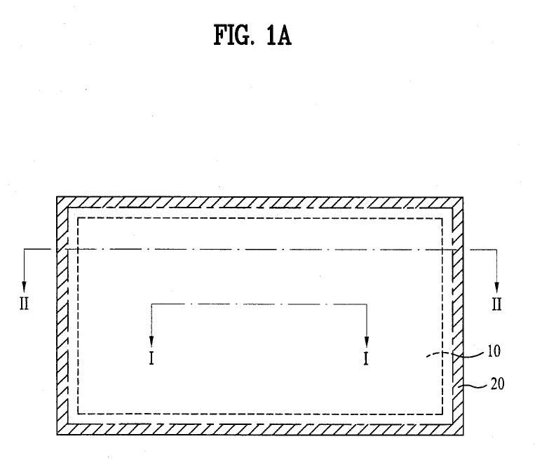

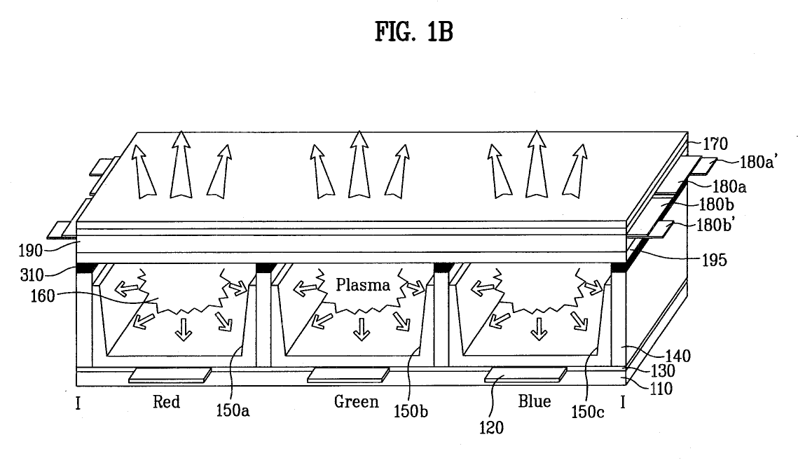

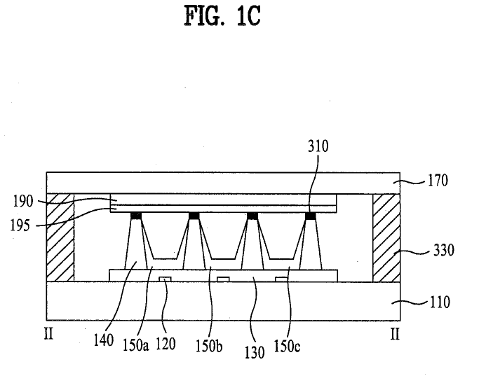

FIGS. 1A to 1C are views illustrating a plasma display panel (PDP) according to embodiments of the present invention. Other embodiments and configurations are also within the scope of the present invention. More specifically, FIG. 1A shows a plane view illustrating a plasma display panel in which a front substrate and a rear substrate are joined together according to an example embodiment of the present invention. FIG. 1B is a perspective view taken along line I-I of FIG. 1A, and FIG. 1C is a sectional view taken along line II-II of FIG. 1A.

As shown in FIG. 1A, the plasma display panel in which a front substrate and a rear substrate are joined together includes a light emitting region 10 and a non-light emitting region 20.

The light emitting region 10 includes a plurality of discharge cells partitioned by barrier ribs and the non-light emitting region 20 is arranged at an edge of the panel and is a bonding part where the front and rear substrates are bonded to each other using an adhesive. The plasma display panel according to an embodiment of the present invention may employ a first adhesive applied onto the barrier ribs of the light emitting region 10, and a second adhesive applied onto the substrate in the non-light emitting region 20, to join the front substrate and the rear substrate.

A more detailed description of the plasma display panel with reference to FIGS. 1B and 1C will now be provided. As shown in FIGS. 1B and 1C, the plasma display panel includes sustain electrode pairs arranged on a front substrate 170. Each of the sustain electrode pairs includes a pair of transparent electrodes 180a and 180b and a pair of bus electrodes 180a′ and 180b′.

The plasma display panel may also include a dielectric layer 190 and a passivation film 195 arranged in this order over an entire surface (or substantially an entire surface) of the front substrate 170 including the sustain electrode pairs.

The front substrate 170 may be formed by processing a glass for display substrates. The processing may include milling, cleaning, and the like.

The transparent electrodes 180a and 180b may be formed by sputtering a material such as indium-tin-oxide (ITO) or SnO₂ on the front substrate 170, followed by photo-etching. Alternatively, the transparent electrodes 180a and 180b may be formed by subjecting the material to chemical vapor deposition (CVD), followed by lift-off.

The bus electrodes 180a′ and 180b′ may be made of general-purpose conductive metals and precious metals.

Examples of the general-purpose conductive metals may include aluminum (Al), copper (Cu), nickel (Ni), chromium (Cr), molybdenum (Mo), or the like. Examples of the precious metals may include silver (Ag), gold (Au), platinum (Pt), iridium (1r), or the like.

Subsequently, the general-purpose conductive metal may be combined with the precious metal in a manner such that the general-purpose metal forms a core and the precious metal forms a shell enveloping the surface of the core.

The dielectric layer 190 may be arranged over the front substrate 170 provided with the transparent electrodes 180a and 180b and the bus electrodes 180a′ and 180b′. The dielectric layer 190 may be made of a transparent glass having a low melting point.

The passivation film 195 made of magnesium oxide may be arranged on the dielectric layer 190. The passivation film 195 may protect the dielectric layer 190 from an impact of positive (+) ions during an electrical discharge, and increase an emission of secondary electrons.

Address electrodes 120 may be arranged on one surface of the rear substrate 110 such that the address electrodes 120 extend in a direction perpendicular to an extension direction of the sustain electrode pairs. A white dielectric layer 130 may be provided over the entire surface (or substantially entire surface) of the rear substrate 110 including the address electrodes 120.

The address electrodes 120 may be made of general-purpose conductive metals and precious metals as the above-described bus electrodes. Examples of the general-purpose conductive metals may include aluminum (Al), copper (Cu), nickel (Ni), chromium (Cr), molybdenum (Mo), or the like. Examples of the precious metals may include silver (Ag), gold (Au), platinum (Pt), iridium (Ir), or the like.

The formation of the white dielectric layer 130 may be carried out by applying materials to the rear substrate 110 via printing or film laminating, and then baking the material.

Then, the barrier ribs 140 may be arranged on the white dielectric layer 130. The barrier ribs 140 may be a stripe-type, a well-type, or a delta-type, for example.

The barrier ribs 140 may include a parent glass and a porous filler. Parent glasses are classified into leaded parent glasses and unleaded parent glasses. Examples of the leaded parent glasses may include ZnO, PbO and B₂O₃, and examples of the unleaded parent glasses may include ZnO, B₂O₃, BaO, SrO and CaO.

The barrier ribs 140 may further include oxides such as SiO₂, Al₂O₃ or the like as the filler.

Red (R), green (G), and blue (B) phosphor layers 150a, 150b, and 150c may be provided between adjacent barrier ribs 140 as shown in FIG. 1B.

The phosphor layers 150a, 150b, and 150c may be formed by mixing a vehicle with phosphor powders to form phosphor pastes, followed by drying and baking.

The phosphor powders may include a blue phosphor material, a green phosphor material and a red phosphor material.

For example, the red phosphor material may be Y(V,P)O₄:Eu or (Y,Gd)BO₃:Eu, and the green phosphor material may be selected from the group consisting of Zn₂SiO₄:Mn, (Zn,A)₂SiO₄:Mn (in which A is an alkaline metal) and combinations thereof.

In addition, the green phosphor material may be used in combination with at least one phosphor material selected from the group consisting of BaAl₁₂O₁₉:Mn, (Ba, Sr, Mg)OₐA₁₂O₃:Mn (in which a is an integer of 1 to 23), MgAlₓO_{y}:Mn (in which x is an integer of 1 to 10, and y is an integer of 1 to 30), LaMgAlₓO_{y}:Tb,Mn (in which x is an integer of 1 to 14, and y is an integer of 8 to 47), and ReBO₃:Tb (Re is at least one rare earth element selected from Sc, Y, La, Ce and Gd).

The blue phosphor material may be BaMgAl₁₀O₁₇:Eu, CaMgSi₂O₆:Eu, CaWO₄:Pb, Y₂SiO₅:Eu, or a combination thereof.

The vehicle may be a mixture of approximately 50% to 80% by weight of an organic binder and approximately 10% to 95% by weight of a solvent.

The organic binder may be an organic polymer including cellulose-based polymers, acryl-based polymers, vinyl-based polymers, or the like.

The cellulose-based polymers that can be used in embodiments of the present invention may include methyl, ethyl, nitrocellulose, or the like. The acryl-based polymers include polymethylmethacrylate, polymethylacrylate, polyethylacrylate, polyethylmethacrylate, polynormalpropylacrylate, polynormalpropylmethacrylate, polyisopropylacrylate, polyisoporpylmethacrylate, polynormalbutylacrylate, polynormalbutylmethacrylate, polycyclohexylacrylate, polycyclohexylmethacrylate, polylaurylacrylate, polylaurylmethacrylate, polystearylacrylate, polystearylmethacrylate, or the like. These acryl-based polymers may be used singly or as a copolymer thereof

Furthermore, the vinyl-based polymers may include polyethylene, polypropylene, polystyrene, polyvinylalcohol, polybutylacetate, polyvinylpyrrolidone, or the like.

These polymers can be used alone, or if necessary, in combination thereof.

Any solvent may be used that is capable of dissolving organic polymers, such as cellulose-based polymers, acryl-based polymers, vinyl-based polymers, or the like.

Examples of the solvent may include organic solvents such as benzenes, alcohols, chloroform, esters, cyclohexanone, N,N-dimethylacetamide, or acetonitrile, or aqueous solvents such as water, an aqueous potassium sulfate solution, or an aqueous magnesium sulfate solution. The solvent can be used alone or in combination thereof.

The phosphor pastes may further include additives such as an acryl-based dispersant for improving flowability of the phosphor paste, a silicone-based antifoaming agent, a leveling agent, an antioxidant, a plasticizer such as dioctylphthalate, and the like.

The additives may be provided in an amount of approximately 0.1% to 5% by weight based on a total weight of the phosphor composition.

This is because, when the content of the additives exceeds the range of approximately 0.1% to 5% by weight based on the total weight of the phosphor composition, printability may be degraded.

Meanwhile, the phosphor layers 150a, 150b and 150c may further include a pigment.

The pigment may improve a bright-room contrast of PDPs by reducing reflectance of incident light. Furthermore, the pigment itself may function to serve as a color filter, thereby improving a color purity and a color coordinate.

Each phosphor layer may include a pigment of approximately 65 to 99.99 parts by weight of a phosphor powder and approximately 0.01 to 35 parts by weight of a pigment.

The pigment contained in the phosphor layers may be an iron oxide pigment, a cobalt green pigment, an emerald green pigment, a chromium oxide green pigment, a chromium-alumina green pigment, a Victoria green pigment, a cobalt blue pigment, a Prussian pigment, a Turkey blue pigment, Co—Zn—Si pigment, and the like, for example.

The pigment contained in the phosphor layers may be selected from α-Fe₂O₃ (Co,Zn)O.(Al,Cr)₂O₃, 3CaO—Cr₂O₃.3SiO₂, (Al,Cr)₂O₃, CoOAl₂O₃, 2(Co,Zn)O.SiO₂, ZrSiO₄, and the like, for example.

The drying of the phosphor layers 150a, 150b and 150c may be carried out at a temperature ranging from approximately 50° C. to 250° C. for approximately 5 to 90 minutes. The baking of the dried phosphor layers 150a, 150b and 150c may be carried out at a temperature ranging from approximately 300° C. to 600° C. for approximately 30 minutes to 60 minutes, under vacuum or an inert gas atmosphere.

Most preferably, the baking may be performed at a low temperature of approximately 400° C. to 550° C. for approximately 30 minutes to 60 minutes.

After completion of forming the phosphor layers 150a, 150b and 150c, the front substrate 170 and the rear substrate 110 may be joined together such that the barrier ribs 140 are interposed between the front substrate 170 and the rear substrate 110.

A first adhesion layer 310 may be formed between the front substrate 170 and each of the barrier ribs 140, and a second adhesion layer 330 may be formed between the front substrate 170 and the rear substrate 110 as shown in FIG. 1C.

The first adhesion layer 310 may be formed over an entire top surface of each of the barrier ribs 140, or on a part of the top surface of the barrier ribs 140. More specifically, and as shown in FIG. 1B, the first adhesion layer 310 may be provided between a top point/surface of each barrier rib 140 and the passivation layer 195.

In the case where the first adhesion layer 310 is formed on a part of the top of the barrier ribs 140, the first adhesion layer 310 may be provided in a center of the top surface of each of the barrier ribs 140.

The first adhesion layer 310 may be formed on the front substrate 170, rather than on the barrier rib 140. The first adhesion layer 310 may also be formed on the dielectric layer 190 or the passivation layer 195 such that the first adhesion layer 310 is provided between the first substrate 170 and the barrier ribs 140.

In the case where the first adhesion layer 310 is formed on the barrier ribs 140, the first adhesion layer 310 may be formed in a region where the front substrate 170 faces the barrier ribs 140 on a surface of the front substrate 170.

A shape of the first adhesion layer 310 may be varied depending upon a shape (e.g. a stripe-type, a well-type, or a delta-type) of the barrier ribs 140.

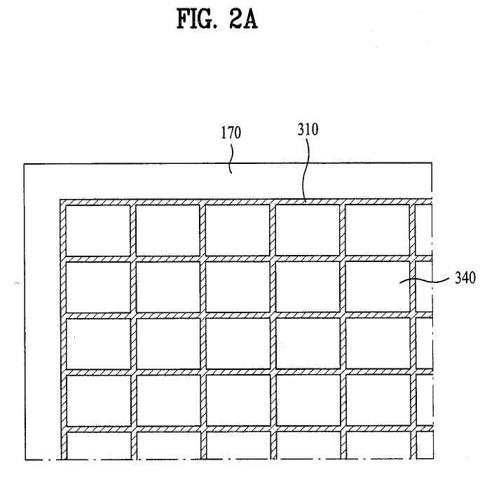

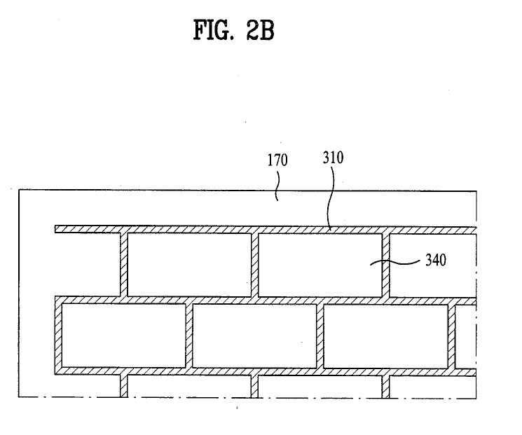

FIGS. 2A and 2B are views illustrating a shape of an adhesion layer according to an embodiment of the present invention. Other embodiments and configurations are also within the scope of the present invention. More specifically, FIG. 2A is a view illustrating a structure in which the first adhesion layer 310 is formed around a discharge space 340 according to a shape of a well-type barrier rib. FIG. 2B is a view illustrating a structure in which the first adhesion layer 310 is formed around the discharge space 340 according to a shape of a delta-type barrier rib.

The first adhesion layer 310 may also be formed on both the front substrate 170 and the barrier ribs 140.

The first adhesion layer 310 may include metal. For example, the first adhesion layer 310 may include at least one of chrome (Cr) and copper (Cu).

The metal may be provided in an amount of approximately 0.1 to 10 parts by weight based on a total weight of the first adhesion layer composition.

The metal may impart a dark color approximate to black to the first adhesion layer 310.

When the first adhesion layer 310 renders a dark color, the plasma display panel can exhibit improved contrast, thus eliminating (or reducing) the necessity of forming an additional black matrix (BM).

In addition to improvement of contrast of the PDP, the inclusion of the metal in the first adhesion layer 310 may enable process simplification, leading to process cost savings.

In accordance with an embodiment of the present invention, the first adhesion layer 310 may include a pigment with a dark color and a light reflectance of 18% or less.

The pigment may include at least one selected from cobalt pigments, copper pigments, carbon black, and carbon nanotubes (CNT).

More specifically, the pigment may include at least one selected from α-Fe₂O₃, (Co, Zn)O.(Al, Cr)₂O₃, 3CaO—Cr₂O₃.3SiO₂, (Al, Cr)₂O₃, CoOAl₂O₃, 2(Co, Zn)O.SiO₂ and ZrSiO₄.

As mentioned above, contrast of the PDP can be improved by introducing the pigment into the first adhesion layer 310.

The second adhesion layer 330 may be arranged at an edge of the front substrate 170 and an edge of the rear substrate 110.

The first adhesion layer 310 may be formed in a light emitting region and the second adhesion layer 330 may be formed in a non-light emitting region.

As such, the first adhesion layer 310 formed on each barrier rib 140 may enable the front substrate 170 and the rear substrate 110 to be firmly fixed, thus minimizing a phenomena of panel warping or panel swelling at high temperatures.

In addition, the first adhesion layer 310 may fill fine gaps between the barrier ribs 140 and the front substrate 170, thereby efficiently reducing noise during electrical discharge.

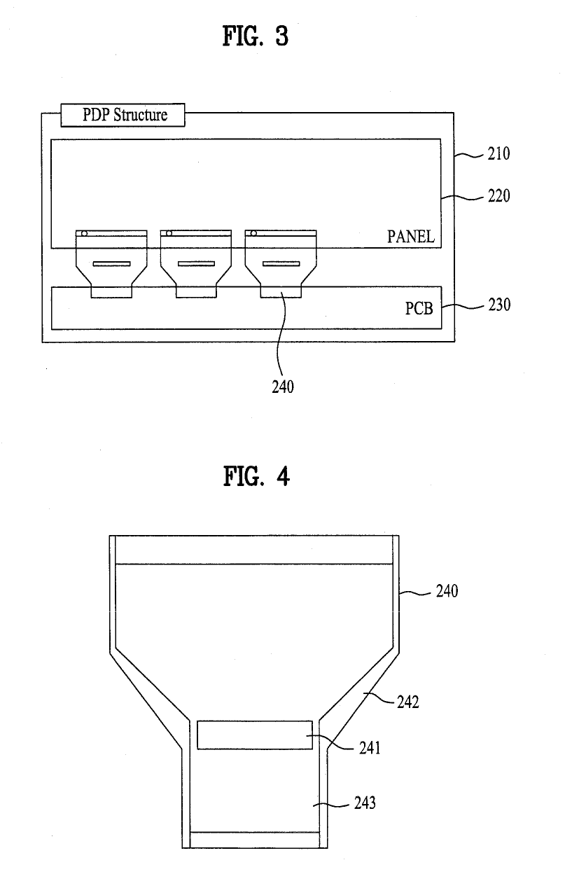

FIG. 3 is a view illustrating a driver and a connection part of a plasma display panel according to an embodiment of the present invention. Other embodiments and configurations are also within the scope of the present invention.

As shown in FIG. 3, the overall plasma display panel 210 may include a panel 220, a drive substrate 230 to supply a driving voltage to the panel 220, and a tape carrier package 240 (hereinafter, referred to as “TCP”) to connect the drive substrate 230 to the electrodes arranged at each of discharge cells of the panel 220.

As discussed above, the panel 220 may include a front substrate, a rear substrate and a plurality of barrier ribs.

An anisotropic conductive film (hereafter referred to as “ACF”) may be used to electrically and physically connect the panel 220 to the TCP 240, and to electrically and physically connect the TCP 240 to the drive substrate 230. The ACF may be a conductive resin film including balls made of gold (Au)-coated nickel (Ni).

FIG. 4 is a view illustrating a structure of a wiring substrate of a tape carrier package (TCP). The TCP 240 may serve as a wiring between the panel 220 and the drive substrate 230 and may be mounted with a driver chip 241. The TCP 240 may include a flexible substrate 242, a line 243 arranged on the flexible substrate 242, and the driver chip 241 connected to the line 243, while receiving power from the drive substrate 230 and supplying the power to a specific electrode of the panel 220.

The driver chip 241 may receive applied low voltage and a small number of drive control signals and alternatively output a large number of signals with a high power. For this reason, a small number of the lines may be connected to the drive substrate 230, while a large number of the lines may be connected to the panel 220.

In some cases, the space adjacent to the drive substrate 230 may be used to connect the drive substrate 230 to the driver chip 241. For this reason, the line 243 may be not separated in a center of the driver chip 241.

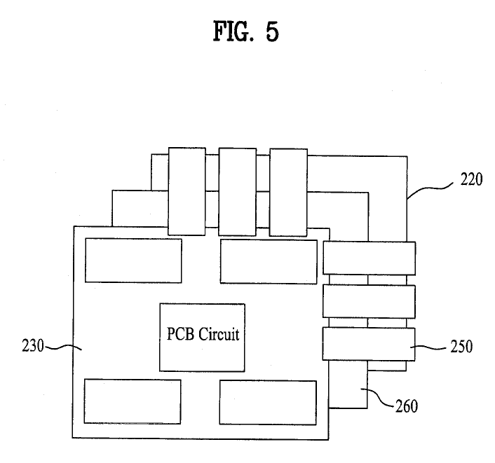

FIG. 5 is a schematic view illustrating an embodiment of the TCP shown in FIG. 4. Other embodiments and configurations are also within the scope of the present invention.

In this embodiment, the panel 220 may be connected to the drive substrate 230 through a flexible printed circuit 250 (hereinafter, referred to as “FPC”).

The FPC 250 may be a film whose internal pattern is formed of polymide. In the present embodiment, the FPC 250 and the panel 220 may be connected to each other through the ACF.

The drive substrate 230 may be a PCB circuit.

FIG. 5 also shows a driver 260 that may include a data driver, a scan driver and a sustain driver. The data driver may be connected to an address electrode to apply a data pulse. The scan driver may be connected to a scan electrode to supply ramp-up waveform, ramp-down waveform, a scan pulse and a sustain pulse.

The sustain driver may apply sustain pulses and a DC voltage to a common sustain electrode.

A total operation time of the plasma display panel may be divided into a reset period, an address period and a sustain period.

During the reset period, ramp-up waveforms may be concurrently applied to the scan electrodes. During the address period, negative scan pulses may be sequentially applied to the scan electrodes, and at a same time, may be synchronized with scan pulses to apply positive data pulses to address electrodes.

During the sustain period, sustain pulses may be alternatively applied to the scan electrodes and the sustain electrodes.

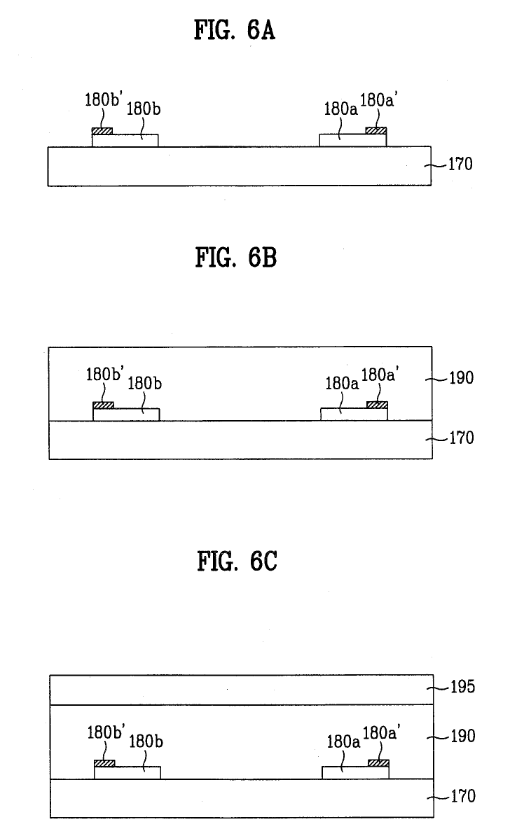

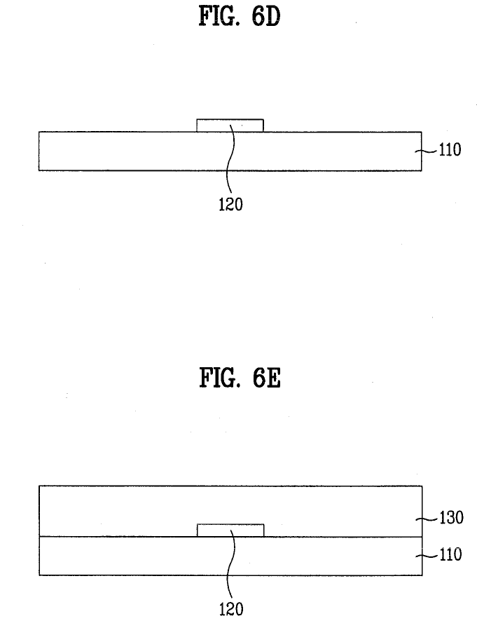

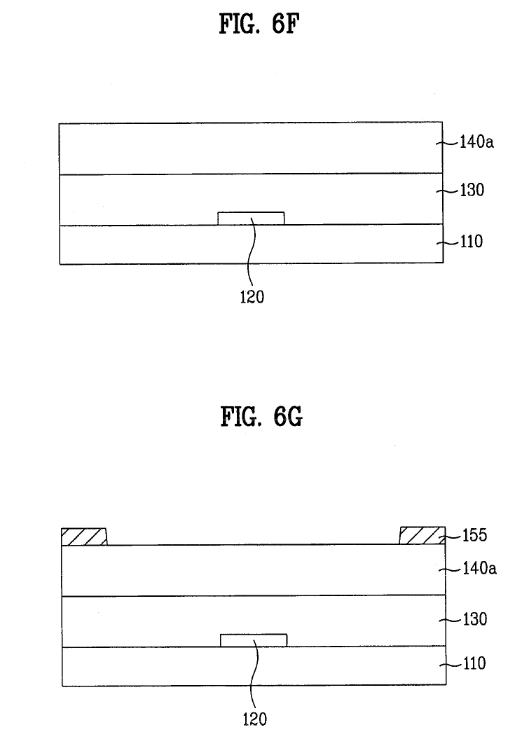

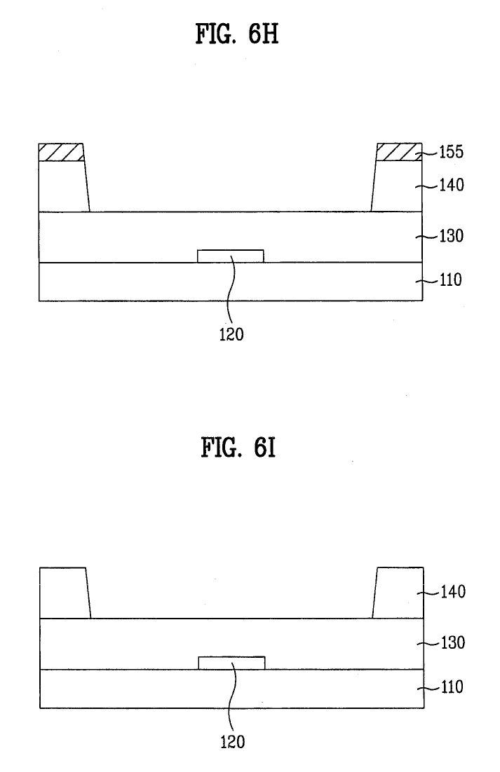

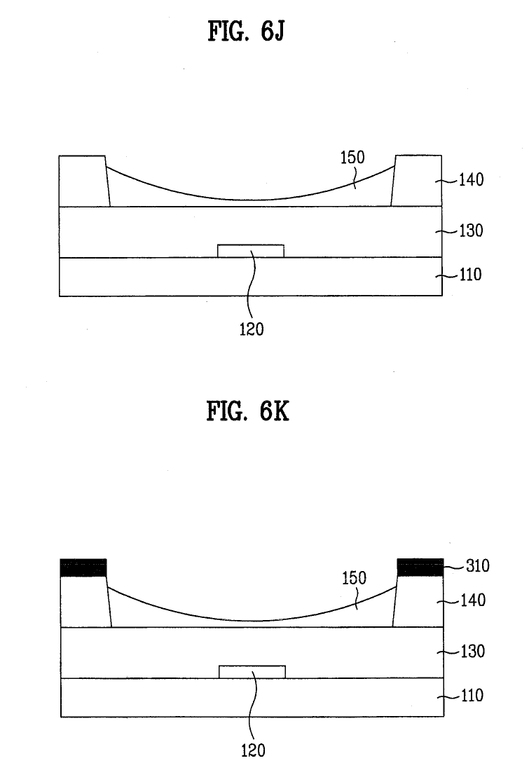

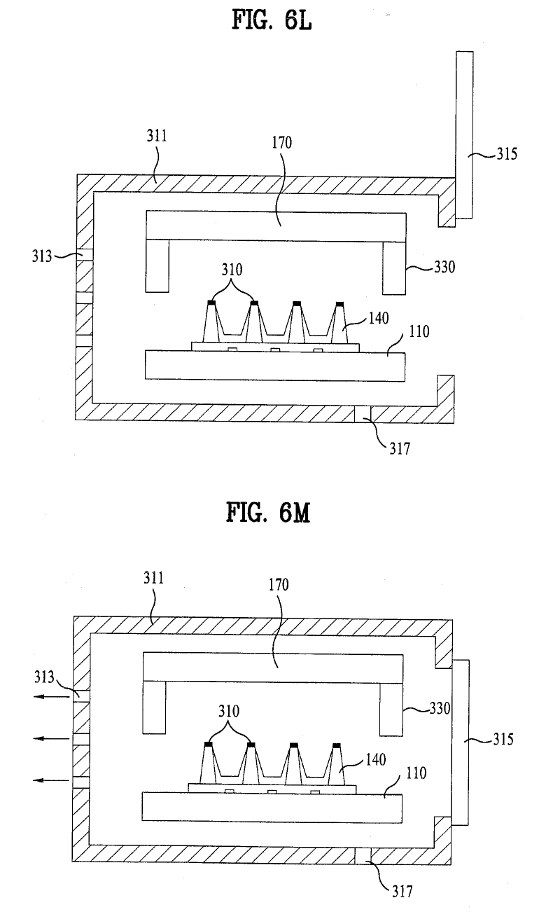

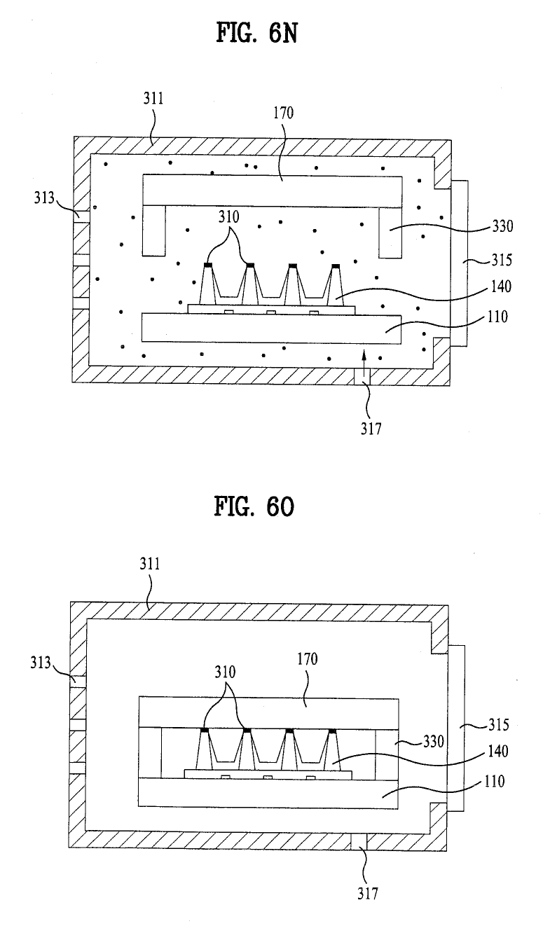

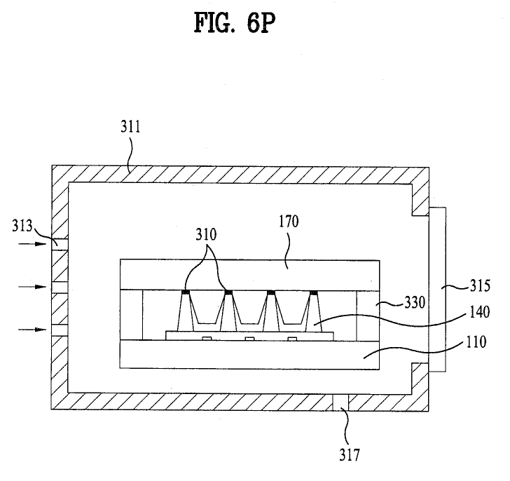

FIGS. 6A to 6P are views illustrating a method for fabricating a plasma display panel according to embodiments of the present invention. Other embodiments and configurations are also within the scope of the present invention.

As shown in FIG. 6A, sustain electrode pairs provided with transparent electrodes 180a and 180b, and bus electrodes 180a′ and 180b′ are formed on the front substrate 170.

The front substrate 170 may be produced by milling a soda lime glass, followed by cleaning.

The transparent electrodes 180a and 180b may be produced by sputtering a material such as indium-tin-oxide (ITO) or SnO₂ on the front substrate 170, followed by photo-etching. Alternatively, the transparent electrodes 180a and 180b may be formed by subjecting the material to chemical vapor deposition (CVD), followed by lift-off.

Then, the bus electrodes 180a′ and 180b′ may be formed using a material composed of general-purpose conductive metals and precious metals, as described above.

The material for the bus electrodes 180a′ and 180b′ may be in a form of a paste prepared by mixing general-purpose conductive metals and precious metals. The material may have a core-shell structure in which the surface of a core made of a general-purpose metal is covered with a shell made of a precious metal.

As shown in FIG. 6B, the dielectric layer 190 may be formed over the entire surface of the front substrate 170 including the transparent electrodes 180a and 180b, and the bus electrodes 180a′ and 180b′.

The formation of the dielectric layer 190 may be performed by screen printing or coating a material such as a transparent glass with a low melting point, or by

Thereafter, the bus electrodes 180a′ and 180b′, and the dielectric layer 190 may be baked through separate steps, or a one-step for the purpose of simplification of an overall process.

The baking temperature may be in a range of approximately 500° C. to 600° C. When the bus electrodes 180a′ and 180b′ and the dielectric layer 190 are concurrently baked, the dielectric layer 190 may inhibit exposure of the bus electrodes 180a′ and 180b′ to oxygen and reduce oxidation of the bus electrode material.

The passivation film 195 may be deposited over the dielectric layer 190.

The passivation film 195 may be composed of magnesium oxide. The protective film 195 may include a dopant, e.g., silicon (Si). The protective film 195 may be formed by chemical vapor deposition (CVD), E-beam, ion-plating, a sol-gel method, a sputtering method, and the like.

Although not shown, the first adhesion layer 310 may be previously formed according to a shape of barrier ribs on the protective film 195 and the second adhesion layer 330 may be previously formed at an edge of the front substrate 170.

Then, as shown in FIG. 6D, the address electrode 120 may be formed on the rear substrate 110.

The formation of the rear substrate 110 may be performed by processing, including milling a glass for display substrates or a soda-lime glass and then cleaning the glass. The address electrode 120 may be formed by a screen-printing method, a photosensitive-paste method, or a photo-etching method following sputtering, using a material such as silver (Ag).

The address electrode 120 may be formed using materials such as general-purpose conductive metals and precious metals and a more detailed description thereof is the same as the above-described bus electrodes.

Then, as shown in FIG. 6E, a rear dielectric layer 130 may be formed on the rear substrate 110 provided with the address electrode 120.

The rear dielectric layer 130 may be formed by screen printing or green sheet laminating using a low-melting point glass and a filler such as TiO₂. The dielectric layer 130 may render white to improve brightness of plasma display panels.

For simplification of the overall process, the rear dielectric layer 130 and the address electrode 120 may be baked through a one-step process.

Thereafter, as shown in FIGS. 6F to 6I, the plurality of barrier ribs 140 to define discharge cells may be formed on the white dielectric layer 130.

First, as shown in FIG. 6F, a barrier rib paste may be applied to a surface of the white dielectric layer 130.

The application of the barrier rib paste 140a may be carried out using a spray coating method, a bar coating method, a screen printing method or a green sheet method. The barrier rib paste may be prepared into a green sheet and then laminated.

The patterning of the barrier rib paste 140a may be carried out by sanding, etching, and a photosensitive paste method.

Then, as shown in FIG. 6G, dry film resists (DFR) 155 may be formed over the barrier rib paste 140a such that they are uniformly spaced apart from each other.

The DFRs 155 may be formed at positions for forming barrier ribs.

As shown in FIG. 6H, the barrier rib paste may be patterned to form barrier ribs 140. That is, when an etching solution is sprayed from the top of the DFR 155, the barrier rib material in the regions where the DFRs 155 are not provided is gradually etched, thereby patterning into a barrier rib shape.

The DFRs 155 may then be removed. After removing the etching solution through a washing process, baking may be performed to complete the barrier rib structure as shown in FIG. 6I.

As mentioned above, the barrier ribs 140 may be of a stripe type, a well type, or a delta type.

Subsequently, the barrier ribs 140 may be dried and baked.

The drying of the barrier ribs 140 may be carried out at a temperature ranging from approximately 50° C. to 250° C. for approximately 5 to 90 minutes. The curing may be carried out at a temperature ranging from approximately 300° C. to 600° C. for approximately 30 to 60 minutes.

As shown in FIG. 6J, phosphor layers 150a, 150b, and 150c may be applied over surfaces of the white dielectric layer facing discharge spaces and side surfaces of the barrier ribs 140.

The applying of the phosphor layers 150a, 150b, and 150c may be carried out such that R, G, and B phosphors are sequentially applied in each discharge cell. The application may be carried out using a screen printing method or a photosensitive paste method.

Subsequently, as shown in FIG. 6K, the first adhesion layer 310 may be formed on the barrier ribs 140.

The first adhesion layer 310 may include a metal such as chrome (Cr) and copper (Cu). The first adhesion layer 310 may further include a pigment with a dark color and a light reflectance of 18% or less.

Although not shown in FIG. 6K, the second adhesion layer 330 may be formed at edges of the rear substrate 110.

As shown in FIG. 6L, the front substrate 170 provided with the second adhesion layer 330, and the rear substrate 110 provided with the barrier ribs 140 and the first adhesion layer 310 may be loaded (or provided) into a chamber 311.

Then, as shown in FIG. 6M, an inlet cover 315 of the chamber 311 may be closed to block inflow of external air.

The air present in the chamber 311 may be discharged to the outside through an air passage(s) 313 using a vacuum pump to vacuumize the inside of the chamber 311.

Then, as shown in FIG. 6N, a discharge gas may be fed into the chamber 311 through a discharge gas inlet 317.

The discharge gas may include at least one of He, Ne and Xe.

As mentioned above, the discharge gas may be fed after vacuumization of the chamber. Alternatively, the feeding of the discharge gas through the discharge gas inlet 317 and vacuumization may be performed simultaneously.

At this time, the discharge gas may be fed into the chamber 311 such that an internal pressure of the chamber 311 is higher than an atmospheric pressure. As a result, the discharge cells may be filled with a high pressure of discharge gas, thus leading to an improvement of brightness of the plasma display panel.

Then, as shown in FIG. 6O, the front substrate 170 and the rear substrate 110 may be joined together.

The front substrate 170 and the rear substrate 110 may be joined through the first and second adhesion layers 310 and 330. The first adhesion layer 310 may fill the fine gaps between the barrier rib 140 and the front substrate 170, thereby reducing noise occurred during electrical discharge.

The joining of the front substrate 170 with the rear substrate 110 using the first and the second adhesion layers 310 and 330 may enable minimization of the phenomena of panel warping or panel swelling at high temperatures. Since the joining process may be performed after discharge gas is injected into discharge cells, a high pressure of discharge gas can be injected into the discharge cells and the plasma display panel with high efficiency can be thus fabricated.

Subsequently, as shown in FIG. 6P, external air may be supplied to inside of the chamber 311 through the air passage 313 to eliminate or reduce the vacuum, thereby completing the joining process.

The first and second adhesion layers 310 and 330 may be formed using a screen printing or a dispensing method.

The screen printing is a method for printing sealing materials in a desired pattern, including arranging screens on the substrate such that the screens are spaced by a predetermined distance apart from each other, and pressing and transcribing pastes required for sealing materials.

The screen printing has advantages of simple fabrication equipment and high material utilization efficiency.

The dispensing method is a method for forming a sealing material, including directly discharging a thick film paste onto a substrate via an air pressure using CAN wiring data used to produce screen masks.

The dispensing method has advantages in that a mask production cost is saved and a shape of a thick film is more various.

As may be apparent from the foregoing, since the joining of the front and rear substrates is performed inside the chamber into which a discharge gas is injected, a high pressure of discharge gas can fill discharge cells and high-efficiency plasma display panels can thus be fabricated.

In addition, adhesion layers formed on barrier ribs enables minimization (or reduction) of the phenomena of panel warping or panel swelling at high temperatures and fills fine gaps between the barrier rib and the front substrate, thereby efficiently reducing noise during electrical discharge.

An embodiment of the present invention may provide a plasma display panel that is free of noise during panel discharge and can exhibit improved discharge efficiency, by which internal gaps are minimized via adhesion layers arranged between an upper substrate and barrier ribs, and a method for fabricating the same.

An embodiment of the present invention may provide a method for fabricating a plasma display panel, wherein process efficiency can be improved and overall process time can be reduced by performing injection of discharge gases and joining of upper and lower substrates inside a vacuum chamber.

A plasma display panel may include a first substrate including a first electrode; a second substrate facing the first substrate, the second substrate including a second electrode; barrier ribs arranged between the first substrate and the second substrate to partition discharge cells, a first adhesion layer arranged between the first substrate and each of the barrier ribs; and a second adhesion layer arranged between the first substrate and the second substrate.

The first adhesion layer may include a pigment with a dark color and a light reflectance of 18% or less.

A method for fabricating a plasma display panel may include preparing a first substrate including a first electrode, and a second substrate including a second electrode, a dielectric, barrier ribs and phosphor layers; forming a first adhesion layer on at least one surface of each barrier rib and the first substrate, and forming a second adhesion layer on at least one surface of the first substrate and the second substrate; and joining the first substrate and the second substrate in a vacuum chamber.

The joining of the first substrate and the second substrate may include: loading the first substrate and the second substrate in a chamber; removing internal air of the chamber to vacuumize the inside of the chamber; feeding a discharge gas into the vacuum chamber; and joining the first substrate and the second substrate.

The feeding of the discharge gas into the chamber may be performed such that an internal pressure of the chamber is higher than an atmospheric pressure.

In addition, the first adhesion layer may be formed on the surface of the front substrate in a region where the front substrate faces the barrier rib. The first adhesion layer may be formed in a light emitting region and the second adhesion layer may be formed in a non-light emitting region.

Any reference in this specification to “one embodiment,” “an embodiment,” “example embodiment,” etc., means that a particular feature, structure, or characteristic described in connection with the embodiment is included in at least one embodiment of the invention. The appearances of such phrases in various places in the specification are not necessarily all referring to the same embodiment. Further, when a particular feature, structure, or characteristic is described in connection with any embodiment, it is submitted that it is within the purview of one skilled in the art to effect such feature, structure, or characteristic in connection with other ones of the embodiments.

Although embodiments have been described with reference to a number of illustrative embodiments thereof, it should be understood that numerous other modifications and embodiments can be devised by those skilled in the art that will fall within the spirit and scope of the principles of this disclosure. More particularly, various variations and modifications are possible in the component parts and/or arrangements of the subject combination arrangement within the scope of the disclosure, the drawings and the appended claims. In addition to variations and modifications in the component parts and/or arrangements, alternative uses will also be apparent to those skilled in the art.

What is claimed is:

1. A plasma display panel comprising:
a first substrate including a first electrode;
a second substrate facing the first substrate, the second substrate including a second electrode;
a plurality of barrier ribs between the first substrate and the second substrate to partition discharge cells;
a first adhesion layer between the first substrate and each of the barrier ribs; and
a second adhesion layer between the first substrate and the second substrate.

2. The plasma display panel according to claim 1, wherein the first adhesion layer is provided in a light emitting region of the plasma display panel, and the second adhesion layer is provided in a non-light emitting region of the plasma display panel.

3. The plasma display panel according to claim 1, wherein the second adhesion layer is provided at an edge of the front substrate and at an edge of the second substrate.

4. The plasma display panel according to claim 1, wherein the first adhesion layer is provided over an entire top surface of the barrier ribs.

5. The plasma display panel according to claim 1, wherein the first adhesion layer is provided on a part of the top surface of the barrier ribs.

6. The plasma display panel according to claim 5, wherein the first adhesion layer is provided in a center of the top surface of the barrier ribs.

7. The plasma display panel according to claim 1, wherein the first adhesion layer includes a metal.

8. The plasma display panel according to claim 1, wherein the first adhesion layer includes at least one metal of chrome (Cr) and copper (Cu).

9. The plasma display panel according to claim 8, wherein the metal is provided in an amount of approximately 0.1 to 10 parts by weight based on a total weight of a composition for the first adhesion layer.

10. The plasma display panel according to claim 1, wherein the first adhesion layer includes a pigment with a dark color and a light reflectance of approximately 18% or less.

11. The plasma display panel according to claim 10, wherein the pigment is at least one selected from cobalt pigments, copper pigments, a carbon black, and carbon nanotubes (CNTs).

12. The plasma display panel according to claim 10, wherein the pigment is at least one selected from α-Fe₂O₃, (Co, Zn)O.(Al, Cr)₂O₃, 3CaO—Cr₂O₃.3SiO₂, (Al, Cr)₂O₃, CoOAl₂O₃, 2(Co, Zn)O.SiO₂ and ZrSiO₄.

13. The plasma display panel according to claim 1, wherein the first electrode includes a pair of sustain electrodes and the second electrode includes an address electrode.

14. The plasma display panel according to claim 1, further comprising:
a phosphor layer in each of the discharge cells, the phosphor layer including a pigment.

15. The plasma display panel according to claim 14, wherein the pigment includes at least one selected from an iron oxide pigment, a cobalt green pigment, an emerald green pigment, a chromium oxide green pigment, a chromium-alumina green pigment, a Victoria green pigment, a cobalt blue pigment, a Prussian pigment, a Turkey blue pigment, and a Co—Zn—Si pigment.

16. The plasma display panel according to claim 14, wherein the pigment includes at least one selected from α-Fe₂O₃ (Co,Zn)O.(Al,Cr)₂O₃, 3CaO—Cr₂O₃.3SiO₂, (Al,Cr)₂O₃, CoOAl₂O₃, 2(Co,Zn)O.SiO₂, and ZrSiO₄.

17. The plasma display panel according to claim 14, wherein the phosphor layer includes 65 to 99.99 parts by weight of a phosphor powder and 0.01 to 35 parts by weight of a pigment.

18. A plasma display panel comprising:
a first substrate having a first electrode provided thereon;
a second substrate having a second electrode provided thereon;
a plurality of barrier ribs between the first substrate and the second substrate to form discharge cells;
a first adhesion material between the first substrate and each of the barrier ribs, wherein the first adhesion material is provided in a light emitting region of the plasma display panel; and
a second adhesion material between the first substrate and the second substrate, wherein the second adhesion material is provided in a non-light emitting region of the plasma display panel.

19. The plasma display panel according to claim 18, wherein the second adhesion material is provided between an edge of the front substrate and an edge of the second substrate.

20. The plasma display panel according to claim 18, wherein the first adhesion material includes a metal.

21. The plasma display panel according to claim 18, wherein the first adhesion material includes a pigment with a dark color and a light reflectance of approximately 18% or less.

22. A method for fabricating a plasma display panel comprising:
providing a first substrate including a first electrode;
providing a second substrate including a second electrode;
providing a plurality of barrier ribs between the first substrate and the second substrate;
forming a first adhesion layer between each of the plurality of barrier ribs and the first substrate;
forming a second adhesion layer between the first substrate and the second substrate; and
joining the first substrate and the second substrate inside a vacuum chamber.

23. The method according to claim 22, wherein joining the first substrate and the second substrate includes:
loading the first substrate and the second substrate inside the chamber;
removing internal air of the chamber to vacuumize the inside of the chamber;
providing a discharge gas into the vacuum chamber; and
joining the first substrate and the second substrate.

24. The method according to claim 23, wherein providing the discharge gas into the chamber is performed such that an internal pressure of the chamber is higher than an atmospheric pressure outside the chamber.

25. The method according to claim 22, wherein the first adhesion layer is provided on a surface of the front substrate in a region where the front substrate faces the plurality of barrier ribs.

26. The method according to claim 22, wherein the first adhesion layer is provided in a light emitting region and the second adhesion layer is provided in a non-light emitting region.
